(19) United States
(12) Patent Application Publication
(10) Pub. No.: US 2017/0278504 A1
(43) Pub. Date: Sep. 28, 2017

(54) ACTIVELY CONTROLLED QUIET HEADSPACE

(71) Applicant: Colin Fraser ROSS, Cambridge (GB)

(72) Inventor: Colin Fraser ROSS, Cambridge (GB)

(21) Appl. No.: 15/471,652

(22) Filed: Mar. 28, 2017

Related U.S. Application Data
(60) Provisional application No. 62/314,206, filed on Mar. 28, 2016.

(51) Int. Cl. G10K 11/178; B60R 13/08

(52) U.S. Cl. CPC G10K 11/1786; B60R 13/0815; G10K 2210/128; G10K 2210/3046; G10K 2210/3028

(57) ABSTRACT

A quiet headspace for the passenger in a vehicle (car/train/bus/aircraft etc.) which comprises a canopy to provide some passive attenuation of the noise coming from the surroundings and within the canopy a noise reduction system comprising, in combination one or more loudspeakers and one or more microphones located close to the passenger's head, and one or more microphones located around the periphery of the canopy.

### CROSS-REFERENCE TO RELATED APPLICATION

This application claims the benefit of U.S. Provisional Application No. 62/314,206, filed Mar. 28, 2016.

### BACKGROUND OF INVENTION

### 1. Technical Field

This invention relates to the active control of sound and more specifically to the creation of a quiet zone around the head of a person using the combination of active and passive means.

### 2. Related Art

Feedback active noise control was proposed by Olson and May in 1953 in a published paper [Olson, H. F., and E. G. May, “Electronic Sound Absorber,” J. Acoust. Soc. Am., Vol. 25, No. 6 November 1953, pp. 1130-1136] and this concept was used to create a quiet region around a passenger's ears as is described by Ross [Ross, C. F. 1980 PhD Thesis, University of Cambridge. “Active Control of Sound”]. It was pointed out in this thesis that any delay in the reception, processing and creation of the opposite noise would limit the frequency range over which noise reduction could be achieved. It further identified that if there was no a priori information about the incoming sound to the controlled that the best strategy was to use the exact opposite of the unwanted noise picked up by the microphone. This clearly showed that the performance is severely limited to the low-frequency where the reference dimension is the distance between the microphone and the loudspeaker (and the reference timescale is the time for an impulse generated by the loudspeaker to be reproduced by the microphone).

Despite this limitation, the concept of feedback cancellation had utility where the incoming noise was not completely random. In particular, for tonal noise fields where information about noise at an instant is related to noise at that location in the future. This then led to the use of a reference signal, for example a propeller tachometer or engine speed sensor, to provide the advance information of the sound that would be heard at the passenger's ears. It moved away from the pure feedback control of Olson to feedforward control. In a car where the sound from the engine is dominant this reference signal provides a great deal about the noise that is to reach the ears. Similarly, in a propeller aeroplane a signal from the propeller tachometers gives good information about the sound to be controlled and has been used very effectively to reduce the noise in passenger aircraft as is described in a published paper by Dorling, Eatwell, Hutchins, Ross and Sutcliffe [Dorling, Eatwell, Hutchins, Ross, Sutcliffe 1989 Journal of Sound and Vibration 128 358-360. A demonstration of active noise reduction in an aircraft cabin]. These systems worked well because the noise was very predictable. In passenger cars, there is also noise from the road and which is relatively random in nature and thus more difficult to control. Despite this there has been some success with systems which use information from accelerometers mounted on the car structure or suspension to provide advance information about the sound that will reach the passenger's ears and this is described in a published paper by D [symbol] browski [D [symbol] browski, 2013 International Journal of Occupational Safety and Ergonomics (JOSE) 2013, Vol. 19, No. 1, 117-125 Methodology of Selecting the Reference Source for an Active Noise Control System in a Car].

It can be seen from the history that without some a priori information about the sound the performance of an active system will be limited. However, with some reference signal and the use of feedforward control reasonable level of performance can be achieved. There is also a body of work on the control of broadband sound in ducts. Here the sound travels along a duct and a signal from a microphone located on the duct gives a good reference signal for the control of the sound as it travels further along the duct. This upstream microphone signal provides a good reference signal with advance information about the sound travelling along the duct to the region where the control is being implemented. For a comprehensive study on this see the aforementioned PhD thesis of Ross. Here we can see that if the sound can be channelled to travel along a long path then the time that the sound takes to travel along that path can be used to give advance information about the sound to be controlled making good control possible. The key challenge in many passenger circumstances is that the noise is coming from many different directions and from many different sources. In that circumstance, there is no obvious reference and pure feedback (Olson) control gives limited performance.

### BRIEF SUMMARY OF THE INVENTION

This disclosure relates generally to the creation of a quiet area around the ears of a passenger in a vehicle thus creating a quiet headspace. The quiet is created by a combination of the canopy which blocks the noise coming from some directions and an active system which creates opposite noise to cancel the noise coming from the remaining directions.

The disclosure relates to the combination of the canopy which shields the passenger from noise reaching their ears from all directions limiting the noise reaching the passenger to a more limited range of directions. The active system has one or more microphone(s) which capture information about the noise which will reach the passenger's ears before the noise has arrived and uses this information to create an opposite noise which generally reduces or opposes the disturbing noise. The active system also uses signals from one or more additional microphone(s) located close to the passenger's ears to adjust the processing of the information from the first mentioned microphones.

### BRIEF DESCRIPTION OF THE DRAWINGS

The system may be better understood with reference to the following drawings and description. The components in the Figures are not necessarily to scale, emphasis instead being placed upon illustrating the principles of the disclosure. Moreover, in the Figures, like referenced numerals designate corresponding parts throughout the different views.

FIG. 1 is a diagrammatic sketch of one type of simple single-channel active control system of this disclosure showing a representation of the signal and paths through signal processing blocks or physical systems.

FIG. 2 is a diagrammatic sketch of an alternative type of simple single-channel active control system of an embodiment of the disclosure again showing a representation of the signal and paths through signal processing blocks or physical systems.

FIG. 3 is a diagrammatic sketch showing a cross-sectional, side view of the canopy, passenger's head, seatback and the key elements of the active control system for creating a quiet space around the passenger's head

FIG. 4 is a diagrammatic sketch showing a front view of the passenger in a seat, surrounded by the canopy.

FIG. 5 shows a multi-channel control system with multiple reference microphone inputs, loudspeaker outputs, and error microphones which would be used for the disclosure.

FIG. 6 is a diagrammatic sketch of an arrangement showing rim microphones (reference microphones) around the canopy edge when viewed from the front.

### DETAILED DESCRIPTION OF THE PREFERRED EMBODIMENTS

One key aspect of the present disclosure is to enable the use of feedforward control for a passenger seat where it is difficult to find a suitable reference signal that characterises the noise to be heard at the passenger's ears. This is achieved by partly surrounding the passenger's head with a canopy thus creating a headspace where the disturbing noise is limited to reaching the passenger's ears from one or a small range of directions. The canopy provides a shield which significantly attenuates the noise from the rear leaving the front open. The disturbing cabin noise will then reach the passenger from this general front direction only. A second key aspect of this disclosure is to use microphones located around the periphery of the canopy to capture information from the incoming sound before it reaches the passenger's ears. These canopy periphery microphones will hereinafter be referred to as reference microphones. A third aspect of this disclosure is the production of a controlling sound from sound sources positioned to generate sound inside the canopy. The signal driving the sound sources, which are commonly loudspeakers, are produced by processing the reference signals in a multi-channel filter.

A fourth key aspect of the disclosure is to use information from the microphones located close to the passenger's ears to adjust or adapt the processing of the reference microphone signals. These microphones, located close to the ears of the passengers will be hereinafter referred to as error microphones. The use of multiple reference microphones and multiple error microphones to adjust the cancelling sound generated by the loudspeakers is described in an MSc Thesis by Tu [Tu Yifeng, 1997 MSc Thesis Virginia Polytechnic Institute and State University “Multiple Reference Active Noise Control”] and the teaching therein is incorporated here by reference. It will be understood by persons skilled in the art how to apply such learning to this disclosure.

A fifth key aspect of the disclosure is to allow adjustment of the size of the cancellation region or relocation of the quietest area away from the error microphones towards the location of the ears. This follows the teaching of Ross 1980 [referred to earlier] where, on page 112 of that reference it is explained how by adjustment of the algorithm the region of quiet can be expanded or relocated. Further work has been undertaken to show how it is possible to characterise the acoustic environment and the incoming disturbance so that a relatively fixed acoustic relationship exists between the sound at the error microphone and the sound at the ear location produced by the cancelling loudspeakers and separately produced by the incoming disturbance. In this further work, which is described in a published paper by Emborg and Ross [“Active Control in the Saab 340” Emborg U and Ross C. F. presented at “The Second Conference on Recent Advances in Active Control of Sound and Vibration”. Virginia Tech, Blacksburg, Va. April 1993.] the locations of the sound sources and error microphones were chosen to minimise the sound at the passenger ear locations. In this and other work measurements were made at the locations of the passenger's ears using microphones which were referred to as monitor microphones. The work in this paper is relevant to this disclosure and the teaching is incorporated by reference to the aspect of selecting the locations of the error microphones ad sound sources with the aim of optimising the quiet at the passenger ear locations. This is particularly effective when the aforementioned acoustic relationships are relatively fixed which implies that the position of the head does not change and the direction of the incoming sound is relatively invariant. The addition of the canopy aids in the second aspect. This fifth aspect is explained in more detail in the section “Expanding or relocating the area of quiet” below.

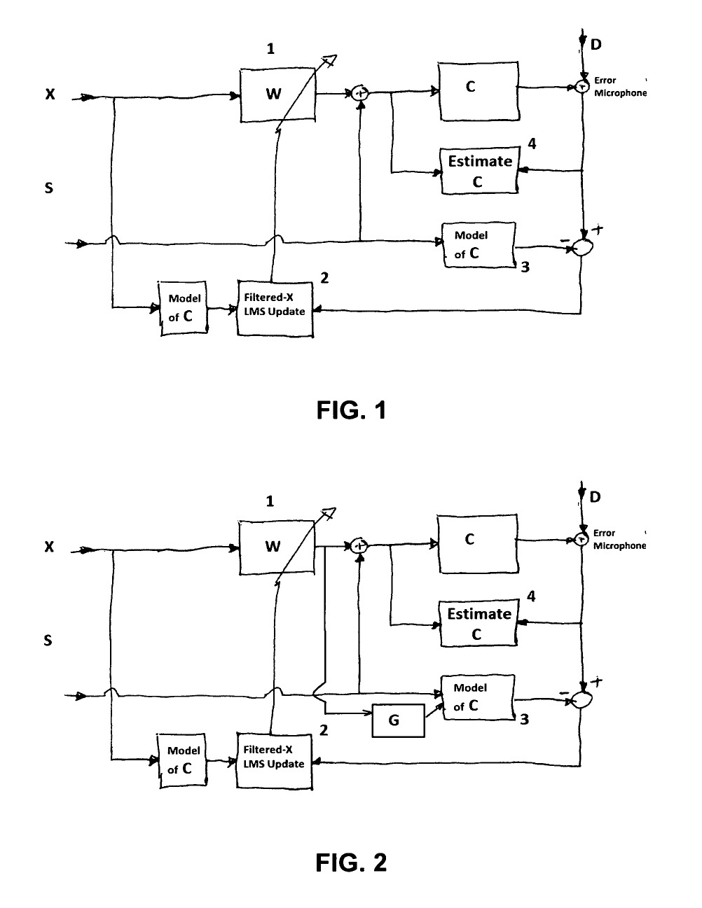

A sixth key aspect of the disclosure is to allow the passenger to listen to music from an audio system whilst maintaining the performance of the active noise control system. This allows the user to maintain a quiet region and thus not to need the level of the audio system to be too loud. By this aspect combined with the aforementioned canopy will ensure that others in the surrounding area will not be disturbed by the passenger's audio system. The teaching of how this aspect is incorporated is set out in outline in FIG. 1. Within this figure the following are referenced:

C=Electroacoustic path (transfer function from the loudspeaker drive signal to the error microphone)

X=reference signal

D=disturbance signal

S=Music signal

1=feed-forward filtering of reference signal

2=Filtered-X LMS update process

3=compensation filter for the removal of estimate of music signal, S, from error

4=Estimate of the Electro-acoustical path, C.

The conventional Filtered-X LMS system is well known [See for example “Theoretical convergence analysis of FxLMS algorithm” I. Tabatabaei Ardekani, W. H. Abdulla, Signal Processing 90 (2010) 3046-3055]. This is the method used by the multi-channel control system for the control of the sound. It will be seen that FIG. 1 of this referenced paper and FIG. 1 of this application are very similar. The sixth aspect, the introduction of music, in a way that does not disturb the sound is achieved by adding the music signal to the loudspeaker drive signal and the addition of the compensation filter, 3, with its output fed to subtract the effect of the music on the error microphone signal. The characteristic of this music removal filter is the same or very similar to the filter used to process the reference signals and corresponds to an estimate of the transfer function from the loudspeaker drive signal to the error microphone. We now distinguish the error microphone signal which is the signal coming directly from the error microphone and the error signal which is the signal after removal of the impact of music. It is the error signal which is used as the input to the conventional FxLMS process.

The position of the loudspeakers relative to the passenger also determines the performance and effectiveness and is may be beneficial to adjust the headrest to select the best location. This is a further, seventh, aspect of the disclosure. Previous work led to consideration and development of the best geometry of the seat and the loudspeakers to ensure that the region of quiet was close to the passenger's ears and could be adjusted by the passenger for maximum comfort and noise reduction. An adjustable silent seat was proposed by Ross in 1998 [Patent application WO0014722A1]. This references and the teaching is hereby incorporated herein.

Having created a quiet personal space for the passenger where they can listen to music or other sounds personal to them without disturbing their neighbours and with microphones positioned close to their head with small modifications to the system it would be possible to add a communication system for the passenger to allow them to speak to other passengers sitting in similarly connected seats or via a telephone to a third party.

### Expanding or Relocating the Area of Quiet

The basic principles of this aspect are well described in the PhD Thesis by Ross. In this case the details of the implementation are set out in FIG. 2. A proportion, G, (where G is a scalar gain) of the cancelling noise is fed through filter 3 (in addition to the music signal, if any) and subtracted from the error microphone output. By this scheme the adaptive process in block 2 will increase the gain of W so that the cancelling sound will be 1/(1-G) louder than would be required to cancel the noise at the error microphone. 1/(1-G) corresponds to α in Ross's Thesis.

The value of G, which can be simply a scalar as envisaged by Ross in 1980, can be adjusted by the user or by a method of sensing the position of the passenger's head and using this position information to select a pre-defined setting to ensure the quiet is best at the passenger's ears. Further work has been done by many on extending this work and the technique has been named by some as the virtual microphone technique [see for example: “Nonlinear active noise control for headrest using virtual microphone control” by Debi Prasad Das, Danielle J. Moreau, Ben S. Cazzolato from Control Engineering practice 21 (2013) 544-555]. Here the block G has become a filter and no longer is added to the input of block 3 (see FIG. 2 of this application) but it's output is subtracted from the error microphone signal directly and in parallel with compensation filter 3. The setting of the filter coefficients of G is undertaken by methods described for example in this referenced paper and it's teaching is incorporated by reference. The key point here is that this technique works well for noise coming in a fixed direction whereby there is a relatively fixed acoustical relationship between the virtual (reference microphone) output and the error microphone output. The use of the canopy ensures that the sound is generally coming from the opening of the canopy and not the back.

### General Arrangement

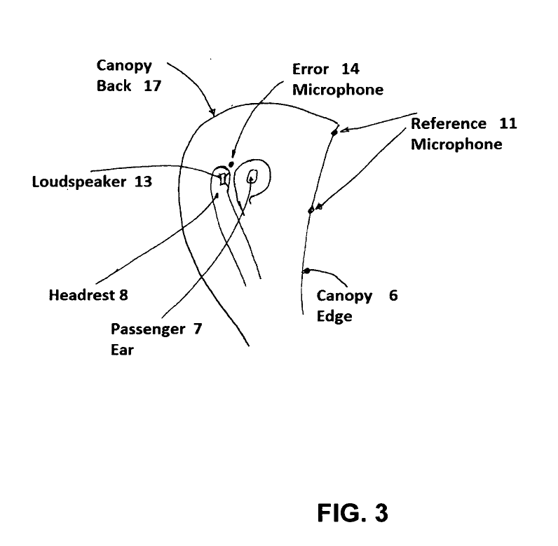

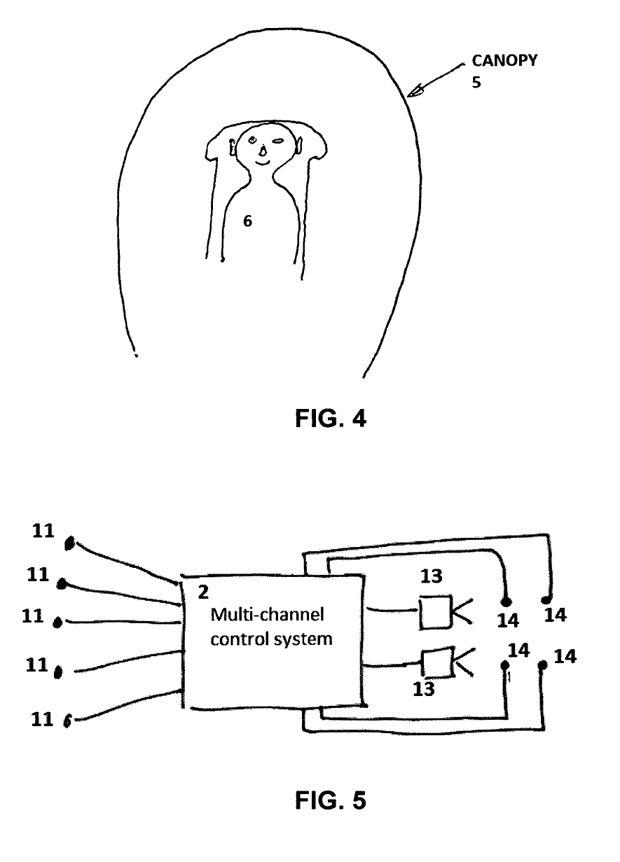

The general arrangement of the disclosure is shown in FIG. 3 and FIG. 4. FIG. 3 shows a side view of the seat within a canopy (5). The back of the canopy (17) has blocked the sound reaching the passenger from the rear, sides, top. Sound does not reach the passenger from below as the seat itself reduces transmission in that direction. The noise that reaches the passenger's ears (7) comes from the open side of the canopy and passes the reference microphones (11) on its way to the ears. By the fact that it takes time for the sound then to travel on to the ears this gives the control system time to launch the cancelling noise from the loudspeakers so that the noise and the cancelling noise reach the ears at the same time thus cancelling each other and creating a quiet region around the head. The normal FXLMS algorithm described in Tu's Thesis would be suitable for this control.

The sound reaching passenger (6) will come from a number of independent sources and from a number of independent directions. The canopy (5) restricts the line of sight to many of these sources and this in principle makes the dominant noise simpler in nature and capable of being represented by a series of microphones (11) located around the rim or edge of the canopy (6). The more complex the sound field the more reference microphones (11) will be required in order to characterise the sound heard at the passenger ears (7). The control system will therefore comprise a number of reference microphones (11) typically between four and eight but not limited to this and at least two error microphones (at least one for each of the passenger's ears). The error microphones (14) are ideally located close to the passenger's ears and can be adjustable as was proposed by Ziegler (U.S. Pat. No. 4,977,600) or fixed in the cushion material of the seat headrest (8) or otherwise held in proximity to the passenger's head. It may be beneficial to have more than one error microphone per ear so that the combination of these microphones is better able to represent the sound hear at the ear. Benefit can also come from summing up the input from more than one microphone to generate a single error microphone signal.

The general multi-channel control system is shown in FIG. 5 where multiple reference microphones (11) are connected to the control system and provide the multiple reference signals (X). The output from the control system (shown in FIGS. 1 and 2 as the input to the electro-acoustic path (C)) is fed to the two loudspeakers (13). The sound from these loudspeakers is combined with the cabin sound (D) to produce a zone of quiet around the ears (7). The signals from the error microphones (14) are a combination of the uncontrolled cabin sound (D) and the controlling sound from the loudspeakers [shown in FIGS. 1 and 2 as the output from the electro-acoustic path (C). The control system is operated according the FXLMS algorithm (which is a gradient descent algorithm) or various improvements which seek to accelerate the convergence to the minimum sound through multi-dimensional quadratic optimisation or otherwise. These algorithms in general are seeking to adjust the filter coefficients of the filter to minimise the weighted quadratic mean of the error signals and the drive signals. Often the minimisation with respect to the drive signals is accomplished with a ‘leak’ in the filter coefficients whereby the filter coefficients are set to (1-beta) of the previous update. Beta being a small number and adjusted to balance the importance of the drive signals in the overall mean.

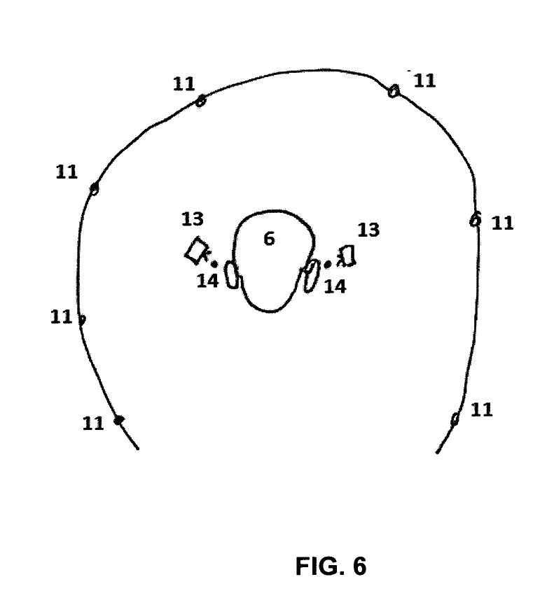

FIG. 6 shows an arrangement of reference microphones (11) around the rim of the canopy with the passenger (6) inside. The loudspeakers (13) are relatively close to the passenger's ears as are the error microphones (14).

It is important that the distance between the loudspeakers and the ears is small so that the time delay for the sound to reach the passenger's ears is small. This time, together with the processing time must be the same as or less than the time for the uncontrolled cabin sound to reach the passenger's ears after it has passed the reference microphones.

The disclosure is not limited to a passenger in an upright position as the principles are the same whatever aspect the passenger and canopy have provided that the canopy or the surrounding structure of the seat tends to ensure that the sound is generally coming from a limited set of directions and not from all directions. Consequently, the word canopy is used to describe a feature which provides a block on the sound reaching the passenger's heads from most directions allowing it only to come from a limited set of directions.

It will be appreciated that the methods and systems described above are set forth by way of example and not of limitation. Numerous variations, additions, omissions, and other modifications will be apparent to one of ordinary skill in the art. In addition, the order or presentation of method steps in the description and drawings above is not intended to require this order of performing the recited steps unless a particular order is expressly required or otherwise clear from the context. Thus, while particular embodiments have been shown and described, it will be apparent to those skilled in the art that various changes and modifications in form and details may be made therein without departing from the scope of this disclosure and are intended to form a part of the disclosure as defined by the following claims, which are to be interpreted in the broadest sense allowable by law.

The various representative embodiments, which have been described in detail herein, have been presented by way of example and not by way of limitation. It will be understood by those skilled in the art that various changes may be made in the form and details of the described embodiments resulting in equivalent embodiments that remain within the scope of the appended claims.

1. An active sound control system for creating a region of quiet close to the head of a passenger comprising:
a canopy which provides a reduction in the disturbing sound reaching the passenger;
reference microphones located on or close to the canopy periphery;
sound sources producing a controlling sound inside the canopy, where the sound sources receive drive signals from a control system fed from the reference microphone signals; and
error microphones located close to the passenger's ears producing signals which are used to adjust filters in the control system.

2. An active control system of claim 1, further comprising the control system where the control system is configured to adjust the control system filters so as to minimise the weighted quadratic mean of the error signals and the drive signals

3. An active control system of claim 1, further comprising the control system, where the control system is configured to adjust the control system filters so as to minimise the weighted quadratic mean of the filtered error microphone signals and the drive signals.

4. An active control system of claim 1, further comprising:
a music signal feed to the sound sources to enable the passenger to listen to music; and
a compensation filter to remove the effect of the music from the error microphone signals.

5. An active control system of claim 1, further comprising an adjustable headrest to enable the passenger to modify the geometry of the seat to maximise comfort and sound reduction.
